(19) United States
(12) Patent Application Publication
(10) Pub. No.: US 2007/0051023 A1
(43) Pub. Date: Mar. 8, 2007

(54) Display assembly for laminar objects

(76) Inventor: Juan Antonio Sosa Bravo, Barrio de Santa Barbara (MX)

Correspondence Address: FISHER, CHRISTEN & SABOL, 1725 K STREET, N.W., SUITE 1108, WASHINGTON, DC, 20006, US

(21) Appl. No.: 10/566,430

(22) PCT Filed: Jul. 30, 2004
(86) PCT No.: PCT/MX04/00055

§ 371 Date: Jun. 28, 2006

(30) Foreign Application Priority Data
Jul. 31, 2003 (MX) PA/A/2003/006860

(51) Int. Cl. G09F 7/00

(52) U.S. Cl. 40/584

(57) ABSTRACT

The invention refers to an display assembly for displaying substantially flat objects, the assembly consists of a molded back support, a transparent cover, and at least two molded fasteners. The object to be displayed is located between the back support and the transparent cover. The fasteners keep the group of laminar objects secured together like a clip and they are fastened or fixed, in a detachable way, to the back support via anchorage means molded for that purpose in the fasteners and in the back support. Every fastener has a structure and arrangement allowing it to be resistant enough to keep the laminar elements together, and being flexible to allow it to be repeatedly fastened and detached from the assembly without breaking. In an additional embodiment of the invention, to provide a display that can modify its dimensions, the back support is provided in the form of modules that can be coupled together to obtain the desired size, by coupling together the necessary number of modules.

### FIELD OF THE INVENTION

This invention is related to displays for displaying substantially laminar objects such as photographs, documents, artwork and the like.

### BACKGROUND OF THE INVENTION

Framing of some objects such as diplomas, photographs, lithographs, paintings as well as other artwork or similar objects is commonly used to display them avoiding deterioration and to provide them with an aesthetic surrounding.

A person with certain abilities or experience generally carries out framing and uses special tools and materials. Therefore, it is generally a costly and complicated task, which doesn't make it an appropriate way to place objects that need to be changed frequently, such as the artwork in galleries, stores or museums or objects that, given their nature, need to be eventually disassembled, for example diplomas, certificates, records, etc.

Photo frames are generally appropriate for small objects but they are not useful for diplomas, certificates, certain artwork, etc.

There are some display assemblies that include a back support element and a transparent protection cover, and the object to be displayed is placed between the support and the cover; these assemblies also include ways to keep the assembly together such as frames, clips, fasteners, contours or the combination thereof made of different materials.

For example, U.S. Pat. No. 3,994,050 by Alfred B. Hans Werner, describes a fastening clip for framing that includes a part made of a flexible material that has two substantially opposing pincers adapted to fasten something between them, and a spring loop extending form the second pincer. The pincer design proposed by Hans Werner has a disadvantage: when the part couples with an assembly to be displayed, it is constantly subject to tension and so, the structure tends to fracture specially at angles where most of the tension is exercised.

On the other hand, the U.S. Pat. No. 4,707,937 by Pietro Astolfi, describes an element for securing and hanging picture frames, which consists of a clip shaped to retain a picture within its frame and with an aperture by which the assembly may be hung from a support. The clip described in Astolfi's patent is useful to fasten the frame to the back of the frame and it is also useful as a hook to hang said frame; it is not a part of the general frame system but it is used as an additional element of the frame. This kind of clip is designed to be used together with a frame, so it is not useful to fasten an assembly without a frame. The design of the fastening element has a weak point at the place where it is fastened to the frame (14): it is subject to a great amount of tension to fasten and separate the clip from the frame if the clip is made of a flexible material, such as a malleable metal, it will tend to deform after fastening and being separated from the frame a few times and, if it is made of a more rigid material such as polycarbonate, it will tend to break.

U.S. Pat. No. 6,298,593 by Daniel Vilims, describes an assembly including a generally rectangular frame having an inwardly extending rear end flange; a backing board having a border or perimeter, and is constructed and arranged to be received within the frame; at least two retainers slidably mounted on the backing board and being movable from a not engaged position, wherein it is not engaged to the rear end flange of the frame and is within the border of the backing board, to a rear end flange engaging position, where a hook of the retainer at a first end of the retainer is positioned beyond the border of the backing board and in front of the rear end flange for holding the backing board in the frame of the frame assembly. The assembly in the United States Patent '593 has a disadvantage: it is somewhat difficult to secure the board to the frame and the closure and securing fasteners are not easy to detach without breaking and therefore, the object to be displayed cannot be changed easily.

US Patent Application no. 2001/0045042 by Martin Dowzall and Vazgen Houssian describes a quick framing system that includes a transparent protective member and support member between which the artwork is positioned, and at least one frame member consisting of a long element with a slot formed along it, where the protective member assembly, the artwork and the support member are inserted. This system has a disadvantage: the frame members can be separated from the assembly very easily; releasing the fastened elements, which could break or suffer damage. Moreover, although other elements to hang the assembly, such as a wall, are mentioned in said patent, it is not very feasible because, given the action of gravity, the assembly would separate form the upper frame member, causing the elements of the assembly to break eventually.

U.S. Pat. No. RE37, 688 E by Daniel E. Vilims describes a picture/poster frame assembly and a retainer for holding components in the frame of the assembly, it is formed by a side wall, a turn in the flange at the rear end of the side wall extending forward to a free end, and a rearward extending flange at the front end of the side wall which provides a forward locator slot between the rearward extending flange and the side wall. The frame assembly also includes two or more retainer members. Each retainer member includes a generally U or V shaped retainer clip having an inner linear/planar leg portion with a flange extending laterally outwardly therefrom. The assembly described above necessarily uses a frame in which the retainer clips are housed and, without the frame, the clips cannot retain the assembly. Therefore, one can predict that, given the shape of the retainer clip, it may damage the object to be described because the end next to the sidewall of the frame is folded so that it gets between the sidewall of the frame and the object to be displayed.

In view of the deficiencies of the products of the state of the art, it is evident that there is a need for a display assembly that is functional in different sizes and may even change its dimensions, so that the object to be displayed can be changed at any time, by quickly placing it in or removing it from the assembly. Moreover, a fastening element is provided, which keeps the assembly together safely and without damaging the object to be displayed, the fastener element can be fastened and detached from the assembly repeatedly and easily without the use of any special tools or the intervention of a qualified person.

### SUMMARY OF THE INVENTION

Therefore, one purpose of the invention is to provide a display for laminar objects that is aesthetic and can be easily and quickly assembled without the help of a frame or tools or the intervention of people with a special skill or training.

Also, it is the purpose of the invention to provide a display assembly that is functional in different sizes, as appropriate for the object to be displayed and can be used either on a horizontal or vertical surface.

Moreover, the invention intends to provide a fastener that will be useful to keep the assembly of substantially laminar elements together without using a frame or a front structure.

Also, the invention considers the provision of fastening elements that will not damage the object to be displayed in any way.

As an additional purpose, the invention intends to provide an assembly that may change its size so it can be useful for objects with different sizes.

These and other purposes are achieved by the assembly of this invention, which uses a molded back support, a transparent cover and at least two molded fasteners; the object to be displayed is located between the back support and the transparent cover. According to the invention, the fasteners keep the group of laminar objects together like a clip and they are fastened or fixed, in a detachable way, to the back support via anchorage means formed for that purpose in the fasteners and in the back support. Every fastener has a structure and arrangement allowing it to be resistant enough to keep the laminar elements together. Each fastener also shows some flexibility that allows it to repeatedly be fastened and detached from the assembly without breaking.

In an additional embodiment of the invention, to provide a display that can modify its dimensions, the back support is provided in the form of modules that can be coupled together so that the desired size may be obtained by coupling together the necessary number of modules.

### BRIEF DESCRIPTION OF THE DRAWINGS

FIG. 1 is a perspective view of the fastener according to the system of the invention;

FIG. 2 is a diagram illustrating the way in which the fastener of the fastening system of the invention is secured;

FIG. 3 is a diagram of a cross section of the back support 8 that shows in detail the shape of a hole formed therein;

FIG. 4 is a scheme of the unassembled parts to be coupled in an arrangement according to the invention;

FIG. 5 illustrates a group of assembled parts fastened with the system of the invention.

FIG. 6 shows the first step to secure the fastener to the system of the invention; and

FIG. 7 shows the second step to secure the fastener to the system of the invention; and

FIGS. 8A and 8B illustrate the coupling action of a pair of modular parts of the back support.

FIG. 9 shows a complete assembly of the group of modular parts coupled to form a back support.

FIGS. 10A and 10B illustrate a variation of the back support provided with a blind hole, as well as the way in which a fastener is secured to the back support.

### DETAILED DESCRIPTION OF THE INVENTION

The display assembly for laminar objects according to the invention consists of a back support 1, a transparent cover 2, and at least two fasteners 3, where the object to be displayed is located between the back support 1 and the transparent cover 2.

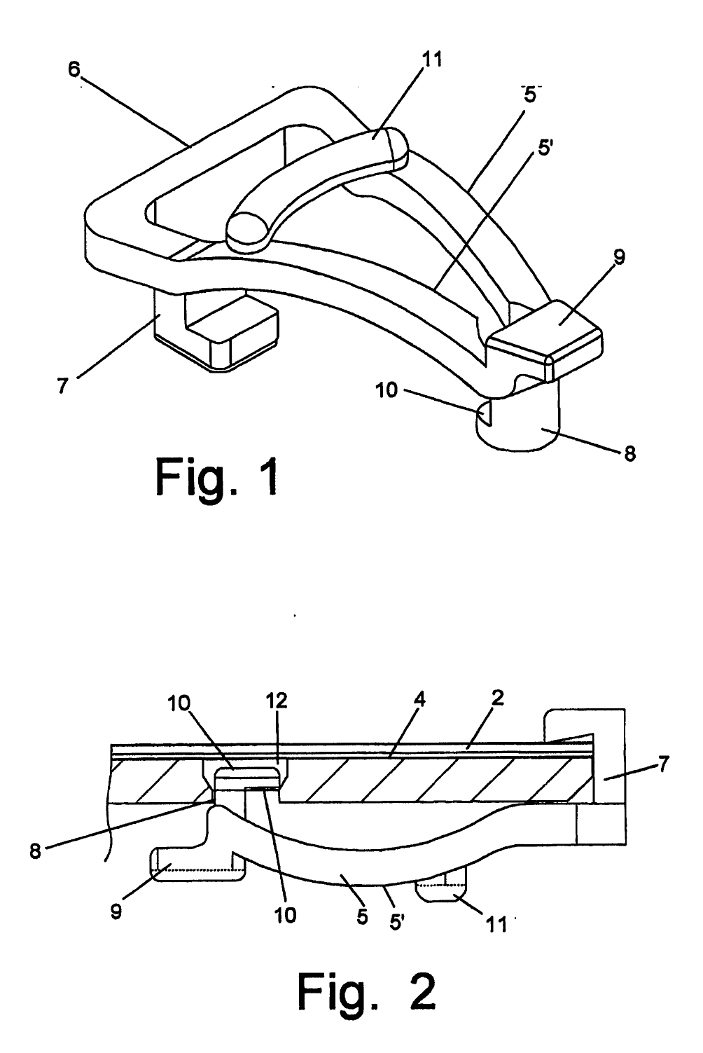

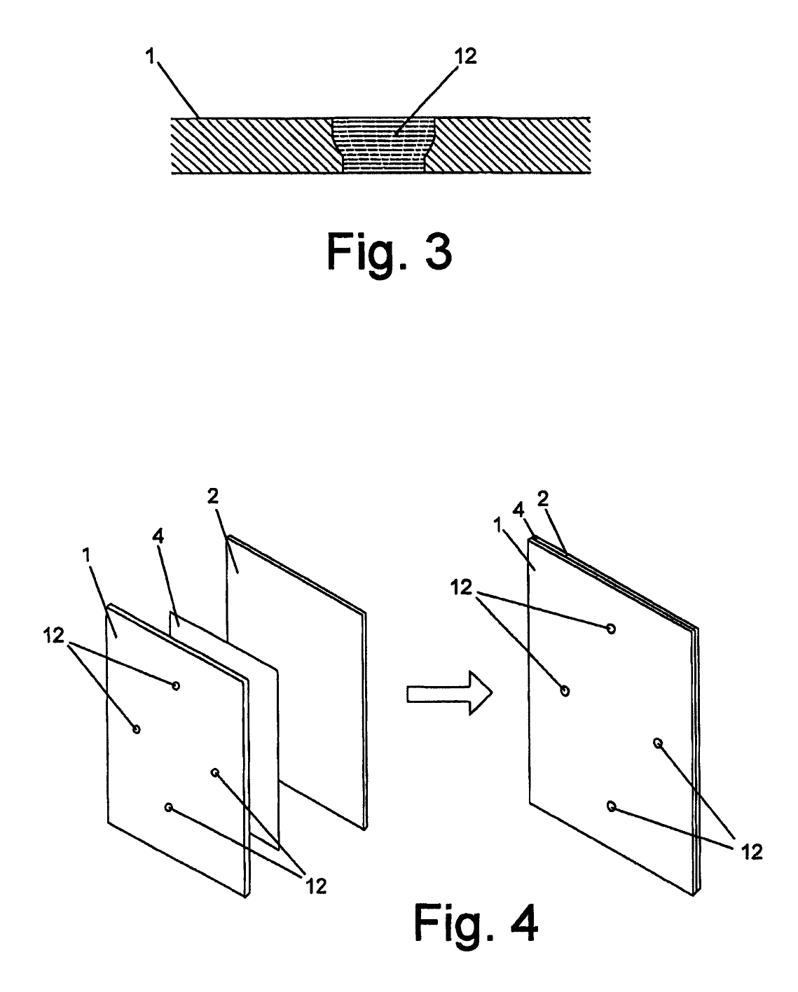

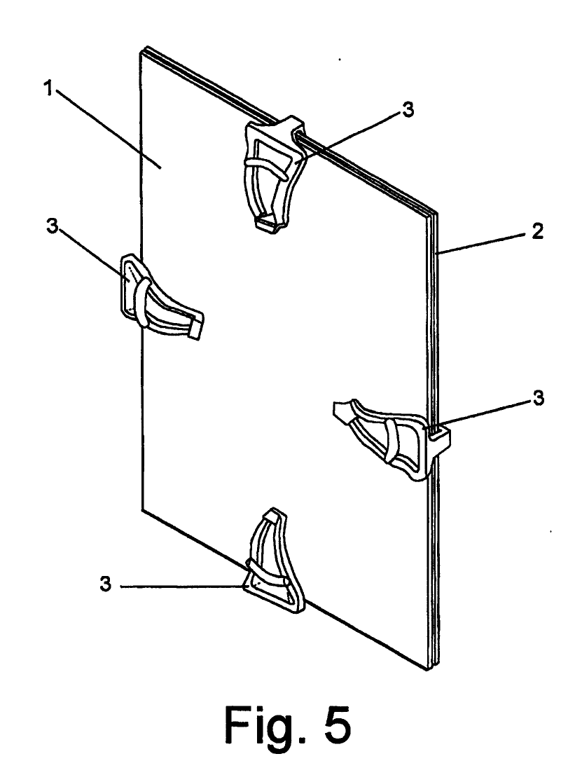

Every fastener 3, shown in FIGS. 1 and 2, consists of a structure of a general triangular shape defined by the sides 5 and 5′ and the base 6, where sides 5 and 5′ are curved in most of their length to provide a spring action that allows expansion and contraction of the triangular structure, while the base 6 is generally flat. On said base 6, a first hook 7 is located, the hook is wide and generally rectangular and is formed in the same unit as the structure of the fastener 3; said hook 7 extends rearwards from the structure of the fastener 3, which helps to support the flat elements of the assembly and to keep them together. A bolt 8 and a second hook 9 are provided at the vertex where sides 5 and 5′ converge; they are formed in the same unit as the triangular structure of the fastener 3, where said bolt 8 extends rearwards from the triangular structure of the fastener 3 and it has a slot 10 on the edge where it couples with said vertex, so that it forms a hook on the opposite edge. The second hook 9 has a trapezoidal shape and extends beyond the vertex at which sides 5 and 5′ converge.

Preferably, the fastener 3 is made of a thermoplastic material that is flexible and resistant enough, such as polycarbonate or the like.

Moreover, in a preferred embodiment of the invention, the fastener 3 comprises a crossbar 11 parallel to base 6, joined to sides 5 and 5′ to provide more resistance to the structure.

The back support 1 showed in FIG. 4 consists of a molded board, preferably made of a thermoplastic resistant material, such as polycarbonate, that provides stiffness to the assembly and that is useful to anchor the fastener 3. On said back support 1, at least two holes 12, in which the bolts 8 of the fastener 3 are introduced, are formed. The bolts are secured inside the holes 12 by the hook shape provided by the slots 10 of the bolts 8.

Preferably, all the edge of the back support 1, meaning the surface at the back of the assembly, has a dead or beveled angle so that the fastener 3 does not touch the edge of the back support, facilitating coupling and detaching the fasteners 3, as illustrated in FIG. 2.

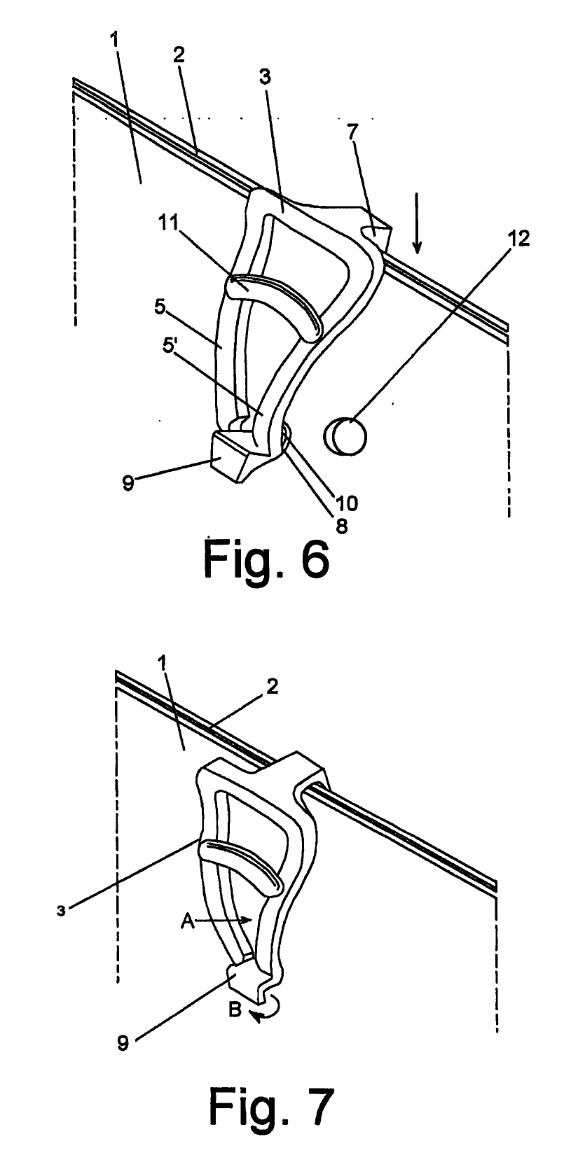

The assembly of the invention is coupled in such a way that an object to be displayed 4 is located between the back support 1 and the transparent cover 2, as indicated in FIG. 4. After that, the fastener 3 is coupled by introducing the support 1, the object 4, and the cover 2 between the triangular structure (5, 5′ and 6) and the hook 7, as shown best in FIG. 6, to keep them together. The fastener 3 is secured to the back support 1 by introducing the bolt in the hole 12, as indicated by arrow A in FIG. 7, so the object is securely held as it is best shown on FIG. 2. To separate the fastener 3 from the back support 1, the fastener 3 is taken by the second hook 9 and lifted, as indicated by arrow B on FIG. 7, thereby releasing the bolt 8 and, after that, the fastener 3 is slid off to separate it from the assembly formed by the support 1, the object 4, and the cover 2.

Once the display assembly is coupled, it can either be placed on a lectern type support or the like, to be displayed on a horizontal surface or it can be hung on a vertical surface using at least one nail or the like, nailed to the vertical surface in such a way that at least one of the fasteners 3 lays on the nail through the crossbar 11. Moreover, in a preferred embodiment, the crossbar 11 shows such a curved shape that, when the crossbar 11 lies on a nail used to hang the completed assembly on a vertical surface, the nail will be place at the center of the crossbar so that the object is centered.

According to a second embodiment of the invention, a display arrangement that can change its size is provided. To achieve this, there is a back support 1 consisting of a group of modular parts (13′, 13″), in which the user can assemble as many modular parts as necessary according to the desired dimensions.

The modular parts that constitute the back support 1 include corner modules 13′ and straight modules 13″, and have coupling means to firmly join them together, such as by a male-female type coupling system, so they can easily be coupled and separated without the help of a tool or any additional element.

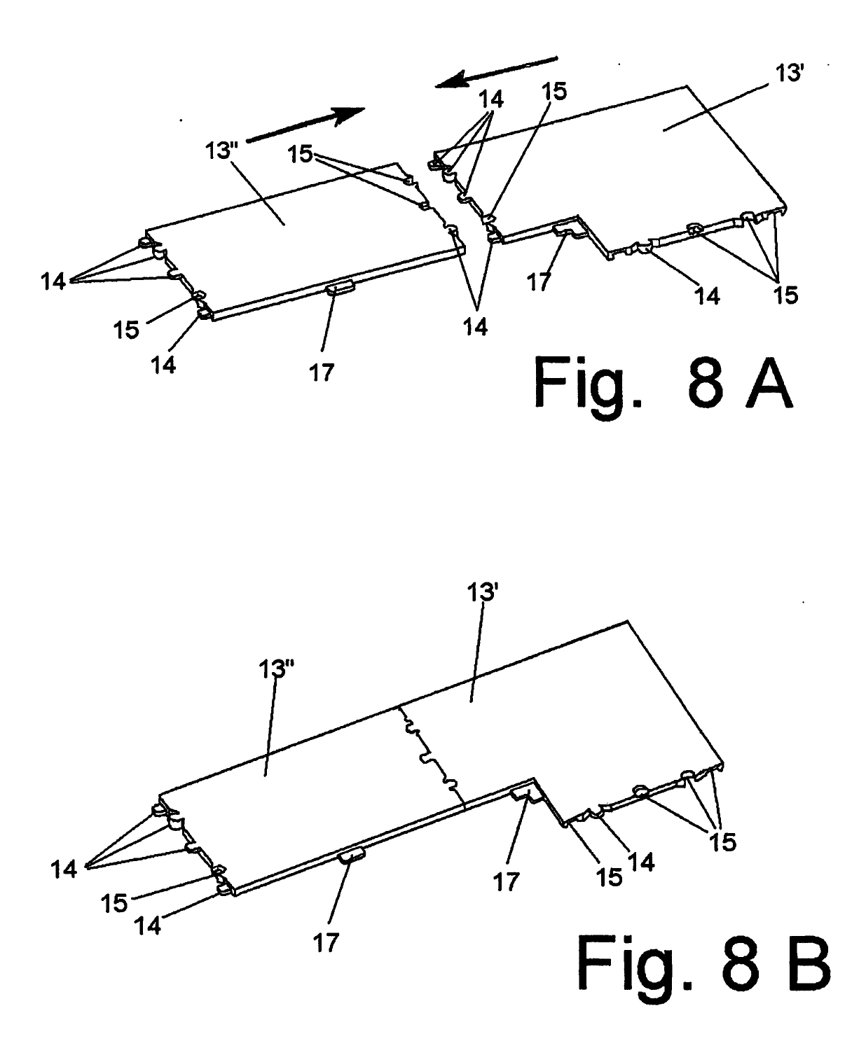

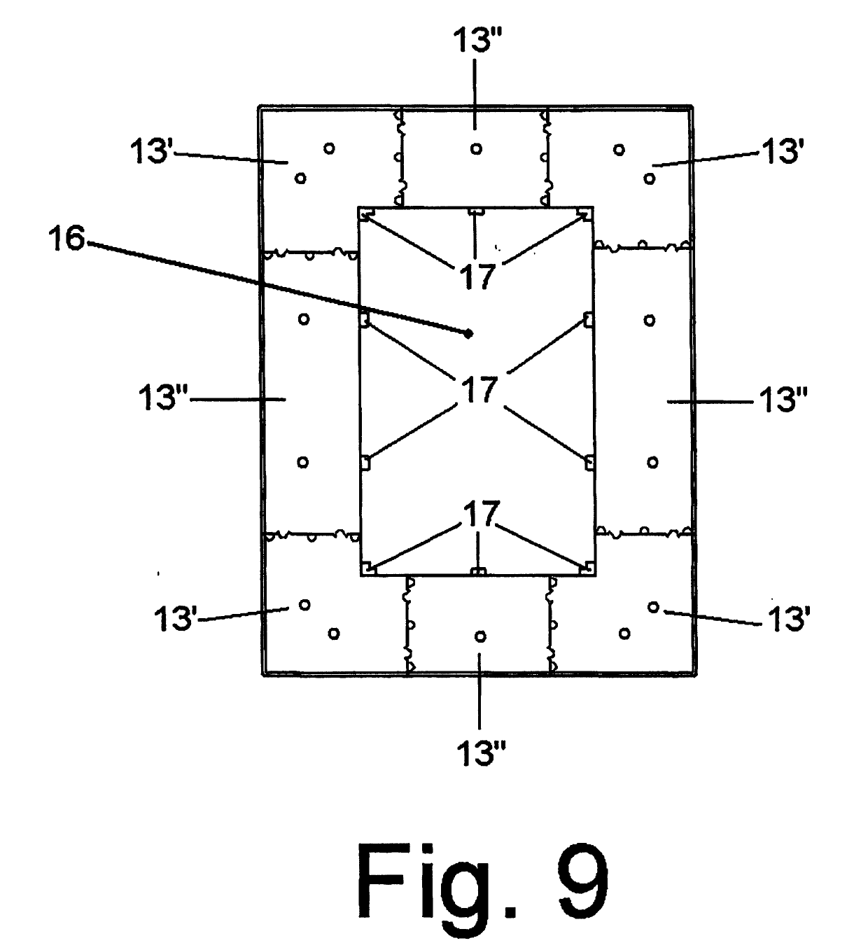

As it can be seen in FIG. 8A, the parts 13′ and 13″ of the back support have coupling elements such as the protrusions 14 and slots 15, to be assembled as illustrated in FIG. 8B. This way, the number of parts 13 necessary in order for the back support 1 to be slightly bigger than the object to be displayed, are coupled together, so that the object is completely protected.

FIG. 9 shows a group of coupled parts 13 to form a complete back support 1, in which four parts 13′ and four parts 13″ have been joined together. Obviously, the back support 1 will always require four corner parts 13′ and as many pairs of parts 13″ will be added as needed to reach the desired size. Moreover, the straight parts 13″ may be of different lengths depending on the demand of the consumers.

As it can be seen in FIG. 9, when the parts 13 are coupled together to form the back support 1, a cavity 16 is formed at the center of the back support, the cavity may be conveniently covered with a piece of laminar material (not illustrated), such as cardboard, in order for the object to be displayed 4 does not go off, fold or suffer any kind of damage. Preferably, the coupled parts 13 are provided with flanges 17 on the inner edge, meaning the edge towards the cavity 16, to support the laminar protection part that covers the cavity 16.

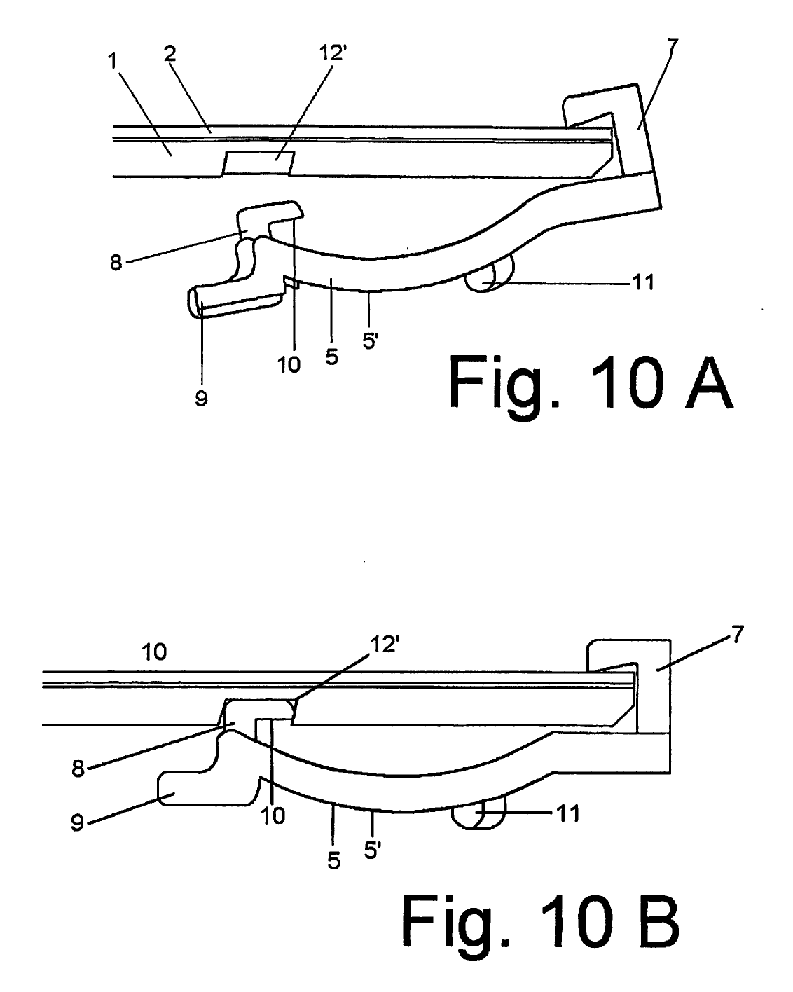

According to the principles of the invention, each modular part 13 comprises at least one hole 12, so that at least one fastener 3 will be coupled to each modular part 13. In a preferred embodiment of the invention, the corner parts 13′ include two holes 12 so that one fastener 3 is located on each side of the corner (see FIG. 10).

Additionally, in yet another embodiment of the invention, the holes 12 provided on the back support 1 are blind holes, as illustrated in FIGS. 10 A and 10 B, so that the surface of the back support 1 in contact with the object to be displayed 4 and the cover 2 does not show any perforation and, in case the object to be displayed 4 does not cover the areas in which the holes are located, they will not be visible, providing the visible surface with a flat finishing.

Preferably, the blind holes 12′ of the back support 1 are cylindrical and are slightly slanted towards the outer edge of the back support, preferably at a 10° angle.

FIG. 10A also illustrates how to couple the fastener 3 to the assembly formed by the back support 1, the transparent cover 2, and the object to be displayed 4; where the fastener 3 is first joined to the assembly by the hook 7, which holds the assembly and then the bolt 8 is inserted in the hole 12′ located as illustrated in FIG. 10 B.

It will be evident to any skilled person in the art that different modifications, variations or adjustments can be made to the invention described herein without departing from its spirit and scope; it should be therefore understood that what is described here is merely illustrative and it does not limit the invention.

1. A display assembly for laminar objects of a kind that comprises a back support and a transparent cover, where the object to be displayed is located between the back support and the transparent cover, and at least two fasteners to keep the assembly of laminar objects secured together, characterized in that every fastener comprises:
a generally triangular structure defined by two sides and a base, where the sides are curved in most of their length, to provide a spring action to the triangular structure;
a first wide and generally rectangular hook, formed as the same unit as the base of the triangular structure, extending rearwards from said triangular structure and being useful to keep the flat elements of the display assembly together;
a bolt formed in the same unit as the triangular structure on the vertex wherein the sides of said structure converge; the bolt extending rearwards from the triangular structure and having a slot on the edge where it joins the vertex so as to form a hook on the opposite edge;
a second trapezoidal hook formed in the same unit as the triangular structure on the vertex where the sides of said structure converge; the hook extending beyond said vertex;
and in that the back support consisting of a molded board with at least two holes located to receive the bolts formed on the fasteners, which are secured inside the holes by the hook shape provided by the slots of the bolts.

2. A display assembly for laminar objects according to claim 1, characterized in that the fasteners are made of a thermoplastic material that is sufficiently flexible and resistant.

3. A display assembly for laminar objects according to claim 2, characterized in that the fasteners are made of polycarbonate.

4. A display assembly for laminar objects according to claim 1, characterized in that the fasteners also show a crossbar parallel to the base of the triangular structure and joined to the sides of said structure, in order to provide it with strength.

5. A display assembly for laminar objects according to claim 4, characterized in that the crossbar has a curved shape.

6. A display assembly for laminar objects according to claim 1, characterized in that the back support is made of a thermoplastic material that is sufficiently flexible and resistant.

7. A display assembly for laminar objects according to claim 6, characterized in that the back support is made of polycarbonate.

8. A display assembly for laminar objects according to claim 1, characterized in that the edge of the back surface of the back support has a dead angle.

9. A display assembly for laminar objects according to claim 1, characterized in that the edge of the back surface of the back support is beveled.

10. A display assembly for laminar objects according to claim 1, characterized in that the holes on the back support are cone-shaped.

11. A display assembly for laminar objects according to claim 1, characterized in that the holes on the back support are cylindrical and are slightly slanted towards the outer edge of the back support.

12. A display assembly for laminar objects according to claim 11, characterized in that the holes on the back support have a 100 inclination.

13. A display assembly for laminar objects according to claim 1, characterized in that the back support is formed by a group of modular parts that can be coupled together; the size of the support may vary depending on the number of parts coupled together.

14. A display assembly for laminar objects according to claim 13, characterized in that the modular parts of the back support include corner parts and straight parts, provided with coupling elements.

15. A display assembly for laminar objects according to claim 14, characterized in that the modular parts of the back support are provided with male-female type coupling elements.

16. A display assembly for laminar objects according to claim 13, characterized in that the modular parts of the back support are provided with flanges on the inner edge so that they can hold a piece of laminar material that covers the remaining cavity at the center of the back support.
